(19) United States
(12) Patent Application Publication
(10) Pub. No.: US 2012/0147036 A1
(43) Pub. Date: Jun. 14, 2012

(54) DISPLAY SYSTEM AND CONTROL METHOD

(75) Inventor: Jouji Yoshikawa, Yokohama-shi (JP)

(73) Assignee: KYOCERA CORPORATION, Koyoto (JP)

(21) Appl. No.: 13/391,666

(22) PCT Filed: Aug. 26, 2010
(86) PCT No.: PCT/JP2010/064518

§ 371 Date: Feb. 22, 2012

(30) Foreign Application Priority Data
Aug. 27, 2009 (JP) 2009-197430

(51) Int. Cl. G09G 5/377; G09G 5/00; G06F 3/01

(52) U.S. Cl. 345/629; 345/156; 345/1.3

(57) ABSTRACT

According to an aspect, a display system includes a first display unit for displaying a first image, a second display unit for displaying a second image; and a control unit for controlling the first display unit and the second display unit. The control unit causes a portion of the second image, which is contained in a specific area in the second display unit, to be displayed on the first display unit as the first image. The control unit makes selection of a change mode where a relative positional relationship between the specific area and the second image is to be changed and a fixed mode where the relative positional relationship between the specific area and the second image is fixed available.

### CROSS-REFERENCE TO RELATED APPLICATION

This application is a National Stage of PCT international application Ser. No. PCT/JP2010/064518 filed on Aug. 26, 2010 which designates the United States, and which is based upon and claims the benefit of priority from Japanese Patent Application No. 2009-197430, filed on Aug. 27, 2009.

### FIELD

The present disclosure relates to a display system and a control method capable of causing a plurality of display units to display images.

### BACKGROUND

Conventionally, a display system, such as a personal computer (PC) or a mobile phone, that causes an image to be displayed has a function of, while displaying an image on its liquid crystal display unit, causing a projector or another display system to also display an image. As electronic device, an apparatus that includes two display units and that can display images on the two display units is also provided.

Mobile projectors that include two display units, which are a liquid crystal display unit and a projector unit, and are compact and easy carrying have also been proposed in recent years. For example, described in Patent Literature 1 is a mobile terminal, which has a projector function, that includes an upper cabinet, a lower cabinet, and a hinge unit that pivotally connects the upper cabinet and the lower cabinet to each other, and that is equipped with a projector that includes a lens and a light source. This mobile terminal includes a liquid crystal display device provided on the upper cabinet.

### CITATION LIST

### Patent Literature

Patent Literature 1: Japanese Patent Application Laid-open No. 2007-96542

### Technical Problem

The configuration that includes two display units is used in some cases in a manner that an operator performs manipulation while viewing a screen of one display unit, while a viewer enjoys viewing a screen on the other display unit. For cases where two display units are used in such a manner, there are a method of displaying a same image on the two display units and a method of displaying different images on the two display units.

First, when a same image is displayed on two display units, an operator can perform manipulation by viewing a screen of one display unit of the display units, thereby checking a screen displayed on a screen of the other display unit. However, this method causes the same image to be displayed on both the display units, resulting in that a screen state of the screen manipulated by the operator is undesirably seen by a viewer. For example, a search screen where a file to be displayed next is searched for, a confidential document displayed on the screen, and the like are undesirably also seen.

On the other hand, when different images are displayed on two display units in a situation where an operator can view a screen on one display unit, to which the operator inputs manipulation, of the display units but cannot view the other display unit, the operator cannot check what is displayed on the other display unit. Accordingly, it is less easy to perform manipulation.

For the foregoing reasons, there is a need for a display system that is easy for an operator, even in a situation where different images are displayed on two display units, to manipulate the images.

### SUMMARY

According to an aspect, a display system includes: a first display unit for displaying a first image; a second display unit for displaying a second image; and a control unit for controlling the first display unit and the second display unit. The control unit causes a portion of the second image, the portion being contained in a specific area in the second display unit, to be displayed on the first display unit as the first image. The control unit makes selection of a change mode where a relative positional relationship between the specific area and the second image is to be changed and a fixed mode where the relative positional relationship between the specific area and the second image is fixed available.

According to another aspect, the control unit displays a mark indicating the specific area on the second display unit, and the mark is any one of a plurality of dots, a line passing through the dots demarcating the specific area, or the mark is one or multiple lines, the one or multiple lines demarcating the specific area.

According to another aspect, the first display unit is another image display mechanism connected via an external communication unit, and the control unit transmits image signals to the first display unit via the external communication unit.

According to another aspect, the display system further includes an input unit, to which an operator inputs manipulation. Shape changing or moving of at least any one of the specific area and the second image is manipulable on a screen of the second display unit by manipulation input to the input unit, and the control unit causes the first image, in which the shape changing or moving of the specific area and the second image is reflected, to be displayed on the first display unit.

According to another aspect, in a situation where the fixed mode is selected, the control unit fixes the relative positional relationship between the specific area and the second image and, in this situation, maintains the relative positional relationship between the specific area and the second image even if manipulation is input from the input unit.

According to another aspect, in a situation where the change mode is selected, the control unit sets the relative positional relationship between the specific area and the second image to be changeable and, when the specific area or the second image is manipulated by the manipulation input from the input unit, causes the first display unit to display a portion in the specific area of the second image having undergone the manipulation as the first image.

According to another aspect, when, in a situation where an image follow mode is selected, a shape of the specific area is changed by manipulation input from the input unit, the control unit changes a shape of the second image to fit the specific area after the input and causes the second image to be displayed on the second display unit.

According to another aspect, the second display unit displays, in addition to the second image, a third image created based on image information that is different from that of the second image. When, in a situation where the second image and the third image overlap in the specific area, the third image is selected, the control unit causes an image where the third image is overlaid on the second image to be displayed on the first display unit as the first image.

According to another aspect, the display system further includes a storage unit for storing image information. When both the second image and the third image are displayed in the specific area, the control unit causes the storage unit to store the image to be displayed on the first display unit as a fourth image.

According to another aspect, the control unit causes the storage unit to store information containing the fourth image and information about a shape of the specific area or the image.

According to another aspect, when it is detected that the specific area or the second image has not been manipulated for a preset time duration, the control unit causes at least any one of the specific area and the second image not to be displayed on the second display unit.

According to another aspect, the display system further includes a notifying unit for displaying a message that is externally received on the second display unit, and the control unit displays the message of the notifying unit on outside of the specific area.

### Advantageous Effects of Invention

According to one aspect, a display system causes a portion of an image displayed on one display unit of display units to be displayed on the other display unit, thereby allowing an operator to ascertain a screen displayed on the other display unit by viewing only a screen of the one display unit. This yields an effect that the operator can manipulate the images to be displayed on the two display units easily.

### BRIEF DESCRIPTION OF DRAWINGS

FIG. 1 is a schematic diagram illustrating a schematic configuration of a display system according to one embodiment.

FIG. 2 is a block diagram illustrating a schematic configuration of the display system illustrated in FIG. 1.

FIG. 3 is an explanatory diagram for explaining an image to be displayed by the display system.

FIG. 4 is an explanatory diagram for explaining images to be displayed by the display system.

FIG. 5 is an explanatory diagram for explaining images to be displayed by the display system.

FIG. 6 is a flow diagram illustrating one example of operations of the display system.

FIG. 7 is a flow diagram illustrating one example of operations of the display system.

FIG. 8 is a flow diagram illustrating one example of operations of the display system.

FIG. 9 is a flow diagram illustrating one example of operations of the display system.

FIG. 10 is an explanatory diagram for explaining an image to be displayed by the display system.

FIG. 11 is an explanatory diagram for explaining images to be displayed by the display system.

FIG. 12 is an explanatory diagram for explaining images to be displayed by the display system.

FIG. 13 is an explanatory diagram for explaining images to be displayed by the display system.

FIG. 14 is an explanatory diagram for explaining images to be displayed by the display system.

### DESCRIPTION OF EMBODIMENTS

The present invention will be described in detail below with reference to the drawings. It should be noted that the present invention is not limited by the description below. It also should be noted that components in the description below include those that will readily occur to those in the art, those that are substantially identical to the components, and those within what is called as the scope of equivalents. A display system will be described below by way of an example of a system, in which a personal computer and mobile electronic device (mobile phone) are connected with a communication line; however, application of the present invention is not limited thereto. Example applications include a system, in which a personal computer and a projector are connected with a communication line, and a system, in which two pieces of mobile electronic device, such as a mobile phone including a display unit, are connected together. Applications are not limited to connecting a plurality of pieces of device with communication lines, but include device provided with a display panel and a projector function in a single body, device having two display panels, and the like. The mobile electronic device is not limited to mobile phones; the present invention is also applicable to a PHS (personal handy-phone system), a PDA (personal digital assistant), a mobile navigation device, a notebook personal computer, a gaming device, and the like that includes at least one display unit.

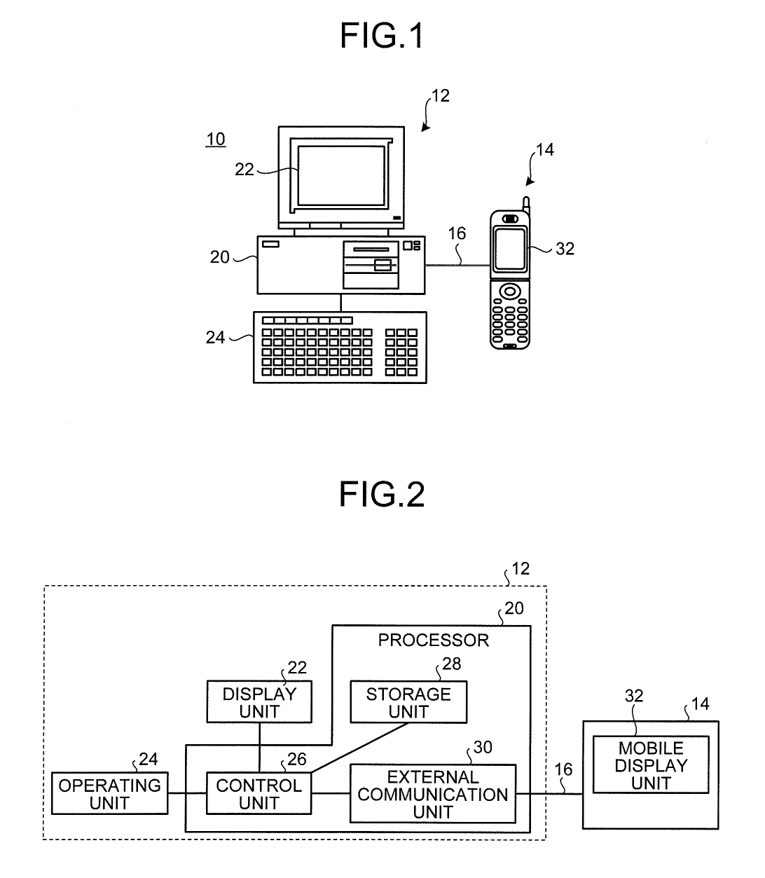

System configuration of a display system 10 is described below using FIG. 1 and FIG. 2. FIG. 1 is a schematic diagram illustrating a schematic configuration of the display system according to one embodiment; FIG. 2 is a block diagram illustrating a schematic configuration of the display system illustrated in FIG. 1. As illustrated in FIG. 1 and FIG. 2, the display system 10 includes a personal computer (hereinafter referred to as “PC”) 12, mobile electronic device 14, and a communication line 16. Each component will be described below.

First, the personal computer (PC) 12 includes a processor 20, a display unit 22 that displays an image, and an operating unit 24, into which an operator enters an instruction. The PC 12 further includes, in addition to these, various components generally provided in a PC, e.g., a storage-medium reading unit (a CD drive, a DVD drive, or a USB terminal), a sound outputting unit, a sound inputting unit, and the like. The processor 20 includes a control unit 26 that controls operations of each unit, a storage unit 28 that stores various information pieces, and an external communication unit 30 that carries out information transmission/reception with other device.

The control unit 26 is a processing unit, such as a CPU (central processing unit), that performs integral control of overall operations of the PC 12 and the display system 10. More specifically, the control unit 26 controls operations of the display unit 22, the external communication unit 30, and the like so that various processing of the display system 10 is executed in an appropriate procedure according to an operation on the operating unit 24 and software stored in the storage unit 28 of the processor 20.

The control unit 26 executes processing based on program(s) (for example, an operating system program, an application program, or the like) stored in the storage unit 28. The control unit 26 includes, for example, a micro processor unit (MPU) and executes various processing of the PC 12 and the display system 10 described above following a procedure instructed by software. More specifically, the control unit 26 sequentially reads instruction codes from the operating system program, the application program, or the like stored in the storage unit 28 and executes processing.

The control unit 26 has a function of executing a plurality of application programs. Examples of the application program to be executed by the control unit 26 include a plurality of application programs, such as an image-reproduction application program that reproduces still images and moving images, an application program that controls, according to an operation on the operating unit 24, an image to be displayed on the display unit 22 and image information to be transmitted to the mobile electronic device 14 via the external communication unit 30, game application programs that cause various games to run, and the like.

The storage unit 28 stores software and data for use in processing performed by the control unit 26. For example, a task for causing the application program described above that controls driving of the projector to run, a task for causing the image-reproduction application program that reproduces still images and moving images to run, and a task that causes the various game application programs to run are stored in the storage unit 28.

Stored in the storage unit 28 are, in addition to these tasks, for example, data obtained by communications and downloading, software for use by the control unit 26 to control the storage unit 28, temporary data for use in a process of processing by the software, and the like. Computer programs and the temporary data for use in the process of processing by the software are temporarily stored in a working area, which is allocated by the control unit 26 to the storage unit 28. The storage unit 28 includes, for example, a nonvolatile storage device (nonvolatile semiconductor memory, such as ROM (read only memory), a hard disk drive, or the like), a readable and writable storage device (e.g., SRAM (static random access memory) or DRAM (dynamic random access memory)), and the like.

The external communication unit 30 transmits/receives information to/from other device over a wired or wireless communication line. For example, to carry out wireless communications, the external communication unit 30 transmits/receives information to/from other device over wireless LAN (local area network) or by infrared communications. To carry out wired communications, the external communication unit 30 transmits/receives information to/from other device over a communication line, such as an electric wire or an optical fiber cable. The external communication unit 30 also includes a connection terminal for connection to the wired or wireless communication line. As the connection terminal, a wireless device or an infrared port can be used for wireless communication, while a port connectable to the communication line (cable) (USB (universal serial bus) port, a LAN port) can be used for wired communications.

The display unit 22 includes a display panel that includes a liquid crystal display (LCD), an organic EL (organic electro-luminescence) panel, or the like. The display unit 22 causes a picture according to picture data or an image according to image data supplied from the control unit 26 to be displayed on the display panel.

The operating unit 24 includes a keyboard that includes input keys, such as numeric keys, letter keys, direction keys, and the ENTER key; when a key entry is made on the keyboard by user operation, the operating unit 24 generates a signal corresponding to the operation. The generated signal is input to the control unit 26 as an instruction of the user. The operating unit 24 is not limited to the keyboard, and a pointing device, such as a mouse or a joystick, can be employed. A touch panel that includes contact-detectable device arranged on a surface of the display unit 22 and detects an entry made by user operation based on information displayed on the display unit 22 and a touched location on the display unit 22 can be used as well. The PC 12 has such a configuration as described above.

The mobile electronic device 14 is a mobile phone that has a wireless communication function and a wired communication function. The mobile electronic device 14 is a mobile phone, in which units are contained in a foldable housing formed by coupling two members with hinges. In the present embodiment, the folding-type housing is used; however, the housing may be a single box-type housing or a slide-out housing of two members. Further alternatively, a housing formed by coupling three or more members can be used.

The mobile electronic device 14 includes, as a display unit, a display unit 32 (hereinafter, also referred to as “mobile display unit”) illustrated in FIG. 1 and FIG. 2. The mobile display unit 32 displays, as a preset image, a standby screen when the mobile electronic device 14 is on standby for receiving or a menu image for use in assisting manipulation of the mobile electronic device 14. The mobile display unit 32 also displays an image of image signals supplied from the PC 12 via the communication line 16.

The mobile electronic device 14 also includes a connection terminal for connection to the communication line 16. As the connection terminal, the various connection terminal described above can be used. The mobile electronic device 14 further includes, in addition to the mobile display unit 32, various types of functions necessary as a mobile phone. For example, the mobile electronic device 14 includes a transmitting/receiving unit that carries out communications with a base station or the like to perform telephone communications, an operating unit, to which an operator inputs manipulation, a sound processing unit that converts sound input via a microphone into signals and generates sound to be output through a receiver or a speaker or a speaker, and the like. The mobile electronic device 14 may include, in addition to the telephone call function, various functions (applications), such as an e-mail function and a sound reproduction function.

The communication line 16 is a cable that connects the external communication unit 30 of the PC 12 to the mobile electronic device 14; the communication line 16 transmits information (signals) originated from the external communication unit 30 to the mobile electronic device 14, and transmits information (signals) originated from the mobile electronic device 14 to the external communication unit 30. As the cable, a coaxial cable, an optical fiber cable, or the like can be used. When wireless communications are to be carried out between the PC 12 and the mobile electronic device 14, the communication line 16 is infrared radiation, radio waves, or the like.

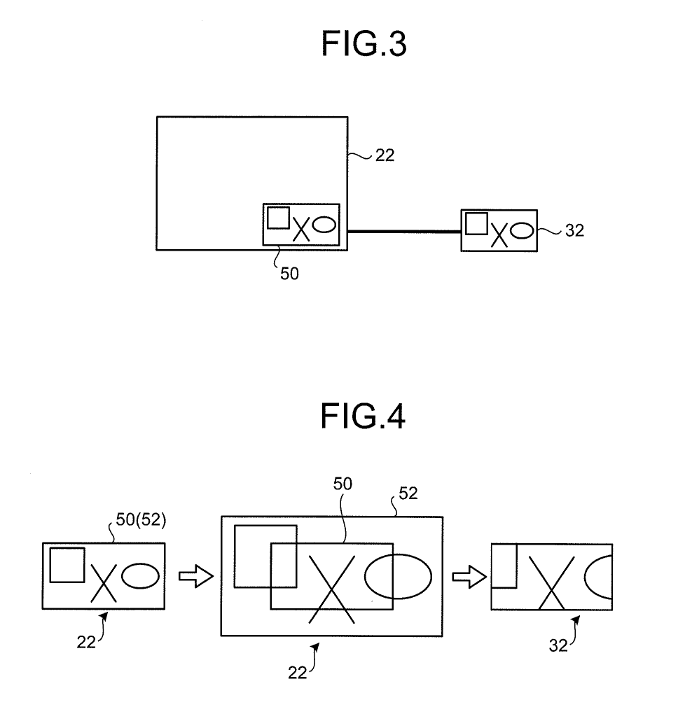

Next, operations of the display system 10 are described below using FIG. 3 to FIG. 5. FIG. 3 to FIG. 5 are explanatory diagrams for explaining images to be displayed by the display system. The control unit 26 of the PC 12 of the display system 10 controls an image to be displayed on the display unit 22 of the PC 12 and an image to be displayed on the mobile display unit 32 of the mobile electronic device 14 based on manipulation instruction input by an operator to the operating unit 24 or a preset instruction. As illustrated in FIG. 3, the control unit 26 is also capable of causing a portion of the image on the display unit 22 of the PC 12 to be displayed on the mobile display unit 32 of the mobile electronic device 14. The control unit 26 also causes a display frame 50 to be displayed on an outer periphery of an area, of the image displayed by the PC 12, that is also displayed on the mobile display unit 32. In other words, the control unit 26 causes, of the image that is principally displayed on the display unit 22, an image in the area surrounded by the display frame 50 to be displayed on the mobile display unit 32. In the example illustrated in FIG. 3, the image surrounded by the display frame 50 is an image in one window (one image that is independently displayed on the screen and that is a preset display area provided to an application). In other words, of the image displayed on the display unit 22, the image in the one window is displayed on the mobile display unit 32. Accordingly, lines (hereinafter, also referred to as “window frame”) indicating the outer periphery of the window are overlaid on the display frame 50. An image displayed as a screen wall paper is one of windows likewise.

In the example illustrated in FIG. 3, the one window is surrounded by the display frame 50, and the window surrounded by the display frame 50 is displayed on the mobile display unit 32; however, the image to be displayed on the mobile display unit 32 can be selected or changed by operator manipulation as required. For instance, in a situation where there are multiple windows, one window can be selected from the multiple windows. The configuration is not limited to causing one window to be displayed on the display unit 22 as it is on the mobile display unit 32; a configuration that causes only a portion of one window to be displayed on the mobile display unit 32 may be employed; another configuration that causes a plurality of windows displayed on the display unit 22 to be displayed on the mobile display unit 32 may be employed.

The control unit 26 determines the image to be displayed on the mobile display unit 32 based on manipulation of determining a position and a size of the display frame 50 that indicates an outer boundary, manipulation of changing them, manipulation of moving a window to inside of the area where the display frame 50 is displayed, manipulation of causing a window to be displayed, or the like. In other words, the size of the display frame 50 can be changed to a desired size; it is possible to enlarge and reduce the display frame 50 on the display unit 22. Likewise, the size of the image to be displayed on the display unit 22 can be changed to a desired size; it is possible to enlarge and reduce the image to be displayed on the display unit 22.

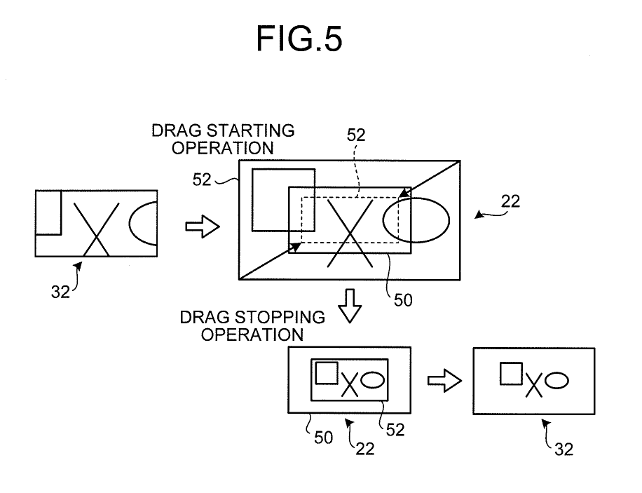

Specific description will be provided below using FIG. 4 and FIG. 5. First, as illustrated on the left-hand side of FIG. 4, an image surrounded by the display frame 50 is displayed in a portion of the display unit 22. In other words, the image is displayed as is on the display unit 22 as illustrated in FIG. 3. Furthermore, as described above, a window frame 52 indicating the outer periphery of the window is overlaid on the display frame 50. Meanwhile, a similar image is also displayed on the mobile display unit 32. In this state, as illustrated in a diagram at center of FIG. 4, manipulation of enlarging only the window frame 52 is performed by operator manipulation. When manipulation of enlarging only the window frame 52 is performed in this way, the image displayed in the window frame 52 is displayed as being enlarged together with the window frame 52, causing the display frame 50 to contain only a portion of the image in the window frame 52. As a result, as illustrated in a diagram on the right side of FIG. 4, only the portion, which is surrounded by the display frame 50, of the image in the window frame 52 is displayed on the mobile display unit 32.

Subsequently, from the state where only the portion of the image in the window frame 52 is displayed on the mobile display unit 32 (i.e., the state of the diagram on the right side of FIG. 4) as illustrated in a diagram on upper left of FIG. 5, manipulation of reducing the window frame 52 to be smaller than the display frame 50 is performed as in a diagram illustrated at upper center of FIG. 5. More specifically, as illustrated at the upper center of FIG. 5, the size and the position of the window frame 52 indicated by solid lines are changed to the size and the position indicated by dashed lines. The size and the position of the window frame 52 can be changed by drag operation. When the window frame 52 is changed to the position and the size indicated by the dashed lines in this way, the window frame 52 becomes smaller than the display frame 50 as illustrated in a diagram at lower center of FIG. 5, causing an image that is displayed outside the window frame 52 and inside the display frame 50 on the display unit 22, in addition to the image in the window frame 52, to be displayed on the mobile display unit 32 as illustrated at lower right of FIG. 5. In FIG. 5, setting for not displaying the window frame 52 is applied to the mobile display unit 32; accordingly, the window frame 52 is not displayed.

As described above, causing only a portion of the image displayed on the display unit 22 (one display unit of the display units) to be displayed on the mobile display unit 32 (the other display unit) allows an operator to check the image on the mobile display unit 32 and the image on the display unit 22 by viewing only the screen of the display unit 22. This permits an operator to manipulate the images displayed on both the display units appropriately even when the operator cannot view the image on the mobile display unit 32. Furthermore, causing only the portion of the image displayed on the display unit 22 to be displayed on the mobile display unit 32 makes it possible for the operator to cause an image that is not permitted to be viewed or undesirably viewed by a viewer of the mobile display unit 32 to be displayed in an area that is not displayed on the mobile display unit 32, or, in other words, in the area outside the display frame 50. This makes it possible to display an image for presentation on the mobile display unit 32, while an explanatory note or a manuscript is displayed on the display unit 22. Moreover, this also makes it possible to search for, while causing an image to be displayed on the mobile display unit 32, an image to be displayed on the mobile display unit 32 next. Thus, causing images to be displayed on the two display units, which are the display unit 22 and the mobile display unit 32, while enhancing operability for an operator can be achieved.

Surrounding, of the image displayed on the display unit 22, the image displayed on the mobile display unit 32 with the display frame 50 allows the operator to recognize the image displayed on the mobile display unit 32 readily. Making the size and the position of the display frame 50 manipulable allows the operator to display an image at any location on the display unit 22 on the mobile display unit 32.

The situation where the one window is enlarged and reduced relative to the display frame has been described with FIG. 4 and FIG. 5; however, the present invention is not limited thereto, and various manipulations can be performed on the display frame and windows. For instance, a configuration where only a required portion of the display unit 22 is caused to be displayed on the mobile display unit 32 by moving the display frame can be employed. Alternatively, a configuration where size adjustment of a display area by drag operation is performed on the window, while the size of the display frame is fixed, may be employed. Further alternatively, a configuration where the display unit 22 displays two windows and the display frame is to be switched from one window of the windows to the other window may be employed. In this case, an image displayed on the mobile display unit 32 is not displayed in such a manner that the displayed image gradually changes but the displayed image is instantly switched from the one window to the other window. These modes where the display frame and the windows can be manipulated independently and relationship between them changes depending on manipulation are a display-frame manipulating mode.

The display system is preferably configured to make selection of a change mode where a relative positional relationship between the display frame 50 (specific area) and an image on the display unit 22 is to be changed (In other words, the display frame 50 is movable in the display unit 22) and a fixed mode where the positional relationship between the display frame 50 (specific area) and the image on the display unit 22 is fixed (In other words, the display frame 50 is unmovable in the display unit 22) available. This makes it possible to control relationship between images displayed on the display unit 22 and the mobile display unit 32 more favorably.

The display system may be configured to display an image in the display frame by utilizing entire screen of the mobile display unit irrespective of the size of the display frame. In short, a configuration where the image in the display frame is displayed full screen on the mobile display unit may be employed. In this case, in a situation where a shape (aspect ratio) of the display frame differs from a shape of the screen of the mobile display unit, the control unit performs enlarging, compressing, or like processing of the image in the display frame and displays the image. Alternatively,, an image, of which pixels or size is adapted to the image displayed on the display unit, may be displayed on the mobile display unit. In other words, the image in the display frame may be displayed as it is on the mobile display unit. In this case, in a situation where the shape (aspect ratio) of the display frame differs from the shape of the screen of the mobile display unit, an image is not displayed on a portion of the screen of the mobile display unit.

In the embodiment described above, the display frame is rectangular; however, the shape of the display frame can be various shapes. For instance, a shape, such as rectangular shape, a circular shape, a star shape, a heart shape, or an arbitrary shape, can be adopted.

The display system may be configured such that, as an image follow mode, which is one mode of the change mode, the display frame and the window frame can be manipulated collectively. This makes it possible to change the size of the window displayed on the display unit or move the window without altering an image displayed on the mobile display unit.

The display system can have setting, as a display-frame fixed mode, which is one mode of the fixed mode, where display is unchangeable even when the display frame on the display unit and the window in the display frame are manipulated by an operator. For this case, a configuration where manipulation is enabled only when a preset key operation is performed is preferably employed. This disables changing the image on the mobile display unit unless a special manipulation is actively performed by an operator.

The display system is preferably configured to be lock setting adaptable. The lock setting is setting that causes only a specific window of windows displayed on the display unit to be displayed on the mobile display unit. There can be adopted some setting that prevents only a specific window of windows displayed on the display unit from being displayed on the mobile display unit. Causing only a specific window or windows except for a specific window to be displayed on the mobile display unit in this way makes it possible to prevent a window that should preferably not be displayed on the mobile display unit from being displayed on the mobile display unit even when an operator accidentally moves the window into the display frame. This allows the operator to manipulate display on the display unit worry-free, and hence operability can be enhanced. In this case, the image displayed on the display unit and the image displayed on the mobile display unit are partially different images because, although images (windows) based on same image information are displayed on the units, an image (the window not to be displayed on the mobile display unit) based on different image information is displayed inside the display frame of the display unit.

When the display system includes a notifying unit that receives a message (e-mail or notice of receipt of an e-mail) from outside (other device) via line or the like and causes the message to be displayed on the display unit, it is possible to prevent, even when an unintended message (report about receipt of an e-mail, contents of an e-mail) is displayed on the display unit as a pop-up or the like, the message from being displayed on the mobile display unit by setting the message to be displayed by the notifying unit as the specific window. This prevents such a situation that receipt of information from outside and/or contents thereof is noticed by a viewer of the mobile display unit.

When the display system includes the notifying unit, a configuration where, in addition to or instead of setting a message to be displayed by the notifying unit as the specific window, the message is displayed outside the display frame may be employed. By causing the display to be made outside the display frame in this way, such a situation that receipt of information from outside and/or contents thereof is noticed by a viewer of the mobile display unit can be prevented as well.

The display system may be configured so as not to display the display frame and/or the image in the display frame of the display unit if the display frame and/or the window in the display frame is not manipulated over a preset period of time. In short, the display system may be configured to display a blank image. Meanwhile, in lieu of the blank image, a screen saver or an image created by adding to a blank image a message notifying that it is an image portion displayed on the mobile display unit may be displayed. In this way, if manipulation is not input to a preset area of the display unit, a notification that manipulation is not performed over a certain period of time can be provided by displaying an image that differs from the image displayed on the mobile display unit. Moreover, displaying the blank image or the screen saver makes it possible to prevent an image from being left on the device.

The display system may be configured to store information about the image displayed on the mobile display unit in the storage unit. A configuration where all the displayed images are to be stored in the storage unit may be employed; however, it is preferable that images designated by operator manipulation are stored in the storage unit. By causing images displayed on the mobile display unit to be stored in this manner, a history about the images displayed on the mobile display unit can be saved. An image displayed by combining images of a plurality of windows can be stored, and hence images created by an operator can be saved. In this case, it is preferable that information about the shape of the display frame and/or information about the shape of the image (image in the display frame) displayed on the mobile display unit are stored in conjunction therewith. By storing the shape of the display frame and/or the shape of the stored image, too, images of various shapes can be stored and reproduced; furthermore, the created image can be re-displayed with its outer shape unchanged.

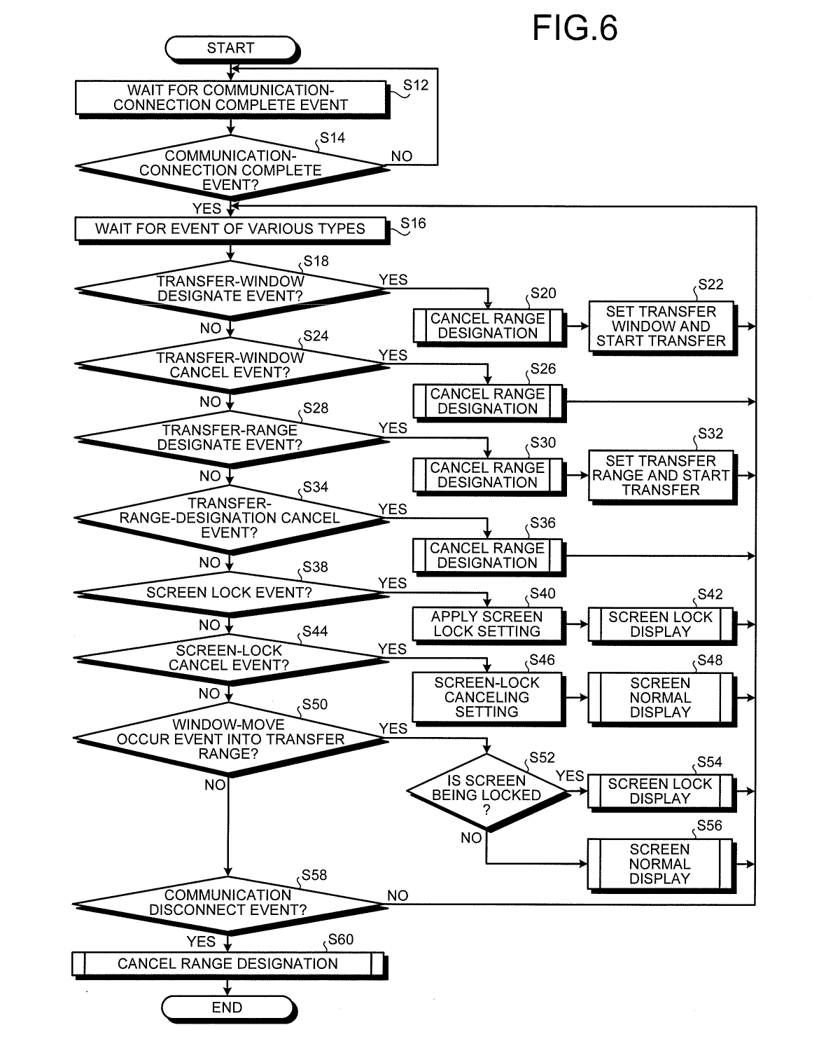

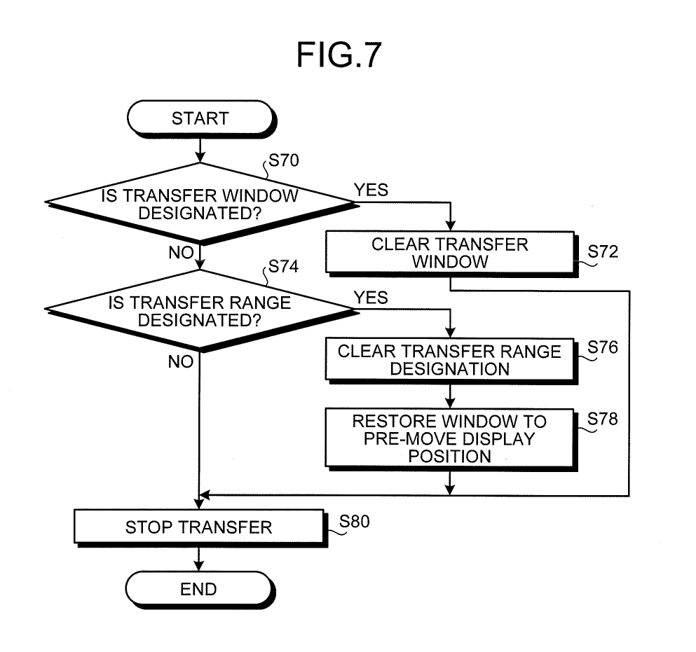

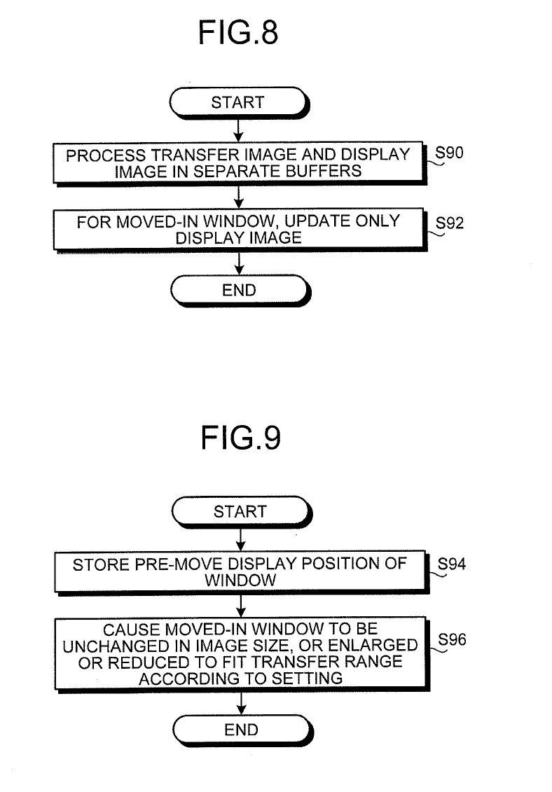

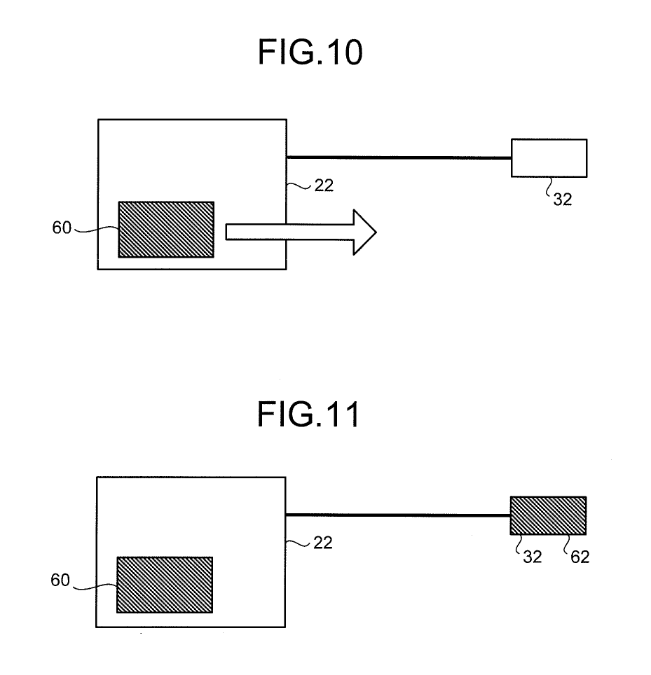

Operations of the display system 10 and images to be displayed are described below using FIG. 6 to FIG. 14. Each of FIG. 6 to FIG. 9 is a flow diagram illustrating an example of the operations of the display system. Each of FIG. 10 to FIG. 14 is an explanatory diagram for explaining the images to be displayed by the display system. Meanwhile, FIG. 7 is a flow diagram illustrating processing of a range-designation canceling process of FIG. 6 more specifically; FIG. 8 is a flow diagram illustrating processing of a screen-lock displaying process of FIG. 6 more specifically; FIG. 9 is a flow diagram illustrating processing of a screen-normal-displaying process of FIG. 6 more specifically. In the example described below, selection of setting (transfer-window designation) for setting a window from among windows displayed on the display unit 22 and causing an area where the window is displayed to be displayed on the mobile display unit 32 and setting (transfer range designation) for causing a preset area of the display unit 22 to be displayed on the mobile display unit 32 can be made by operator manipulation.

First, as illustrated in FIG. 6, at Step S12, the control unit 26 waits for a communication-connection complete event. The communication-connection complete event is an event that notifies that the PC 12 and the mobile electronic device 14 are connected with the communication line 16. Before processing at Step S12 is started, the control unit 26 is in a state where the PC 12 is not connected to the mobile electronic device 14. Upon detecting any event at Step S12, the control unit 26 proceeds to Step S14.

At Step 514, the control unit 26 determines whether the event detected at Step S12 is the communication-connection complete event. When determining that it is not the communication-connection complete event at Step S14 (No), the control unit 26 performs processing of the event detected at Step S12, and thereafter proceeds to Step S12 to wait for an event. In other words, the control unit 26 repeats Step S12 and Step S14 until the control unit 26 detects the communication-connection complete event.

When determining that it is the communication-connection complete event at Step S14 (Yes), the control unit 26 waits for an event of various types at Step 516. More specifically, at Step S16, the control unit 26 waits for detection of a preset event, and proceeds to Step S18 when the event is detected. If the event is detected at Step S16, the control unit 26 determines a type of the detected event by performing processing from Step S18 through Step S58, and performs processing of the event. Description will be provided below.

First, at Step S18, the control unit 26 determines whether the detected event is a transfer-window designate event. More specifically, whether it is an event that sets one window as an object to be transferred, or, in other words, an object to be displayed on the mobile display unit 32, is determined. When determining that it is the transfer-window designate event at Step S18 (Yes), the control unit 26 performs the range-designation canceling process at Step S20.

The range-designation canceling process is described below using FIG. 7. The range-designation canceling process is a process that is to be performed for other event as well, and is a process that cancels setting for displaying an image on the mobile display unit 32, or, in other words, a process that stops image display on the mobile display unit 32. First, at Step S70, the control unit 26 determines whether a transfer window is designated, or, more specifically, whether it is in a state where a window to be transferred (a window as an image to be displayed on the mobile display unit 32) has been designated. When determining that it is in the transfer-window designated state at Step S70 (Yes), the control unit 26 clears a transfer window at Step S72. In other words, setting where a preset window is designated as the window to be transferred is reset. Thereafter, the control unit 26 proceeds to Step S80.

When determining that it is not in the transfer-window designated state, or, in other words, a window to be transferred is not designated at Step S70 (No), the control unit 26 determines whether a transfer range is designated, or, more specifically, it is in a state where a range to be transferred (range, or area, of the display unit 22 as an image to be displayed on the mobile display unit 32) has been designated at Step S74. When determining that it is in the transfer-range designated state at Step S74 (Yes), the control unit 26 clears the transfer range designation at Step S76. More specifically, setting where a preset range is designated as the range to be transferred is reset. Thereafter, the control unit 26 restores windows to pre-move display positions at Step S78. More specifically, in a case where the window in the preset area (i.e., the display frame) has been moved in the transfer-range designated state, each window is moved to a position where the window has been displayed before the transfer-range designated state. Thereafter, the control unit 26 proceeds to Step S80.

When determining that the transfer range is not designated, or, in other words, a range (area) to be displayed on the mobile display unit 32 is not set at Step S74 (No), or when performing processing at Step S72 or Step S78, the control unit 26 stops transfer at Step S80. More specifically, at Step S80, the control unit 26 stops transmitting image signals (image information) to the mobile display unit 32, placing the mobile display unit 32 in a state where no image is displayed thereon. The control unit 26 performs processing described above as the range-designation canceling process.

The description is continued returning to FIG. 6. When performing the range-designation canceling process at Step S20, the control unit 26 sets a transfer window and starts transfer at Step S22. More specifically, the control unit 26 sets a window to be transferred (i.e., the window to be displayed on the mobile display unit 32) from among the windows displayed on the display unit 22 based on the transfer-window designate event detected at Step S18. Furthermore, the control unit 26 transmits information about an image of the set window to the mobile electronic device 14 and starts processing for causing the mobile display unit 32 to display the transmitted image. More specifically, as illustrated in FIG. 10, the control unit 26 transfers, in a state where no image is displayed on the mobile display unit 32, an image 60 in a window displayed on the display unit 22 to the mobile display unit 32, and causes the mobile display unit 32 to display an image 62 as illustrated in FIG. 11. Although the image 62 can differ from the image 60 in aspect ratio, pixels, or the like, the image 62 is an image generated from same image information as that of the image 60. Thereafter, the control unit 26 proceeds to Step S16.

Subsequently, when determining that the event is not the transfer-window designate event at Step S18 (No), the control unit 26 determines whether the event is a transfer-window cancel event at Step S24. When determining that the event is the transfer-window cancel event at Step S24 (Yes), the control unit 26 performs the range-designation canceling process at Step S26, and proceeds to Step S16. The range-designation canceling process at Step S26 is a process similar to that (the process of the flow diagram illustrated in FIG. 7) at Step S20; at Step S26, designation of the transfer window is cancelled, and image display on the mobile display unit 32 is stopped.

When determining that the event is not the transfer-window cancel event at Step S24 (No), the control unit 26 determines whether the event is a transfer-range designate event at Step S28. When determining that the event is the transfer-range designate event at Step S28 (Yes), the control unit 26 performs the range-designation canceling process at Step S30. The range-designation canceling process at Step S30 is also a process similar to that (the process of the flow diagram illustrated in FIG. 7) at Step S20. When performing the range-designation canceling process at Step S30, the control unit 26 sets a transfer range and starts transfer at Step S32. More specifically, of an area of the image displayed on the display unit 22, an area to be transferred, or, in other words, the area of the image to be displayed on the mobile display unit 32, is set based on the transfer-range designate event detected at Step S28. Furthermore, the control unit 26 transmits information about the image of the set range to the mobile electronic device 14, starts processing for causing the mobile display unit 32 to display the transmitted image, and thereafter proceeds to Step S16.

Subsequently, when determining that the event is not the transfer-range designate event at Step S28 (No), the control unit 26 determines whether the event is a transfer-range-designation cancel event at Step S34. When determining that the event is the transfer-range-designation cancel event at Step S34 (Yes), the control unit 26 performs the range-designation canceling process at Step S36, and proceeds to Step S16. The designated-range canceling process at Step S36 is also a process similar to that (the process of the flow diagram illustrated in FIG. 7) at Step S20; at Step S36, designation of the transfer range is cancelled, and image display on the mobile display unit 32 is stopped.

Subsequently, when determining that the event is not the transfer-range-designation cancel event at Step S34 (No), the control unit 26 determines whether the event is a screen lock event at Step S38. Screen lock setting is setting that causes, even when a new window is moved into the display frame of the display unit 22, an image of the new window not to be displayed on the mobile display unit 32. The screen lock event is an event that applies the screen lock setting to setting regarding an image to be displayed on (transferred to) the mobile display unit 32. When determining that it is the screen lock event at Step S38 (Yes), the control unit 26 applies the screen lock setting at Step S40, performs the screen-lock displaying process at Step S42, and thereafter proceeds to Step S16. The screen-lock displaying process will be described later.

Subsequently, when determining that the event is not the screen lock event at Step S38 (No), the control unit 26 determines whether the event is a screen-lock cancel event at Step S44. More specifically, the control unit 26 determines whether it is an event that cancels the screen lock setting. When determining that it is the screen-lock cancel event at Step S44 (Yes), the control unit 26 applies screen-lock canceling setting at Step S46, performs the screen-normal-displaying process at Step S48, and thereafter proceeds to Step S16. The screen-normal-displaying process will be described later.

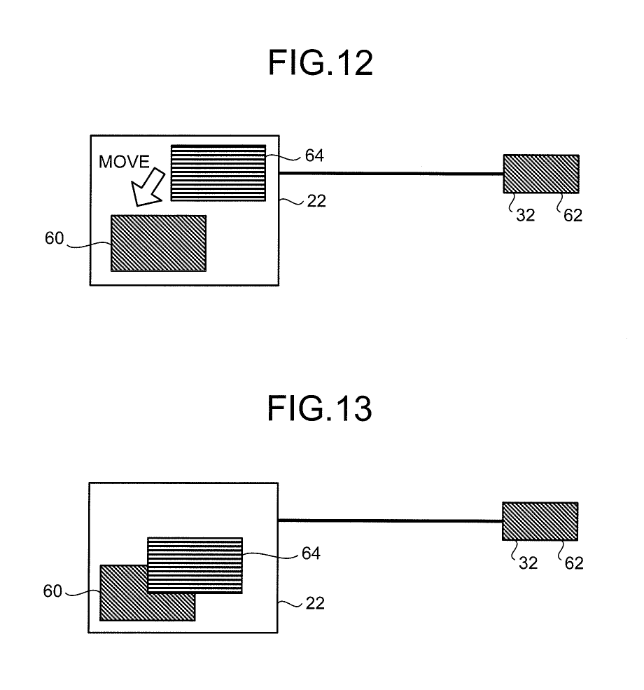

Subsequently, when determining that the event is not the screen-lock cancel event at Step S44 (No), the control unit 26 determines whether it is a window-move occur event into the transfer range (display frame) at Step S50. More specifically, the control unit 26 determines whether an image 64 of another window is moved onto the image 60 in the display frame displayed on the display unit 22 as illustrated in FIG. 12.

When determining that it is the window-move occur event at Step S50 (Yes), the control unit 26 determines whether the screen is being locked at Step S52. More specifically, the control unit 26 determines whether the screen-lock setting is applied. When determining that the screen is being locked at Step S52 (Yes), the control unit 26 performs the screen-lock displaying process at Step S54, and proceeds to Step S16.

The screen-lock displaying process is described below using FIG. 8. First, at Step S90, the control unit 26 processes a transfer image and a display image in separate buffers. More specifically, a process of creating the transfer image (image to be displayed on the mobile display unit 32) and the display image (image to be displayed in the display frame of the display unit 22) as separate images is started. After starting creation of the two images at Step S90, the control unit 26 performs a process of updating, for a moved-in window, only a display image at Step S92. In other words, in the screen-lock displaying process, the control unit 26 creates a transfer image and the display image separately, and when an image of another window is moved into the display frame, the control unit 26 updates only the display image. Accordingly, as illustrated in FIG. 13, even when the image 60 and the image 64 corresponding to the display image overlap, the image of the other window in the display frame is not displayed in the transfer image, but only the image 62 that is created based on image information similar to that of the image 60 is displayed in the transfer image.

The description is continued returning to FIG. 6. Subsequently, when determining that the screen is not being locked at Step S52 (No), the control unit 26 performs the screen-normal-displaying process at Step S56 and proceeds to Step S16.

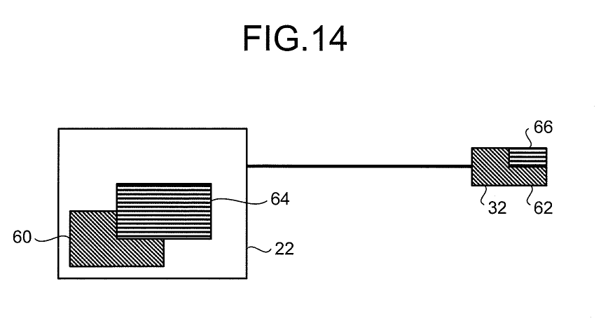

The screen-normal-displaying process is described below using FIG. 9. First, the control unit 26 stores pre-move display positions of windows at Step S94. More specifically, the control unit 26 stores positions, at which the windows are displayed on the display unit 22 before the window to be moved at Step S50 is moved. Thereafter, at Step S96, the control unit 26 causes the moved-in window to be unchanged in image size, or enlarged or reduced to fit the transfer range depending on setting. More specifically, at Step S96, the control unit 26 creates a transfer image by adjusting a size and the like of a portion of the other window moved into the display frame according to display setting of the mobile display unit 32. As a result, as illustrated in FIG. 14, if the image 60 and the image 64 serving as a display image overlap, in the transfer image, an image 66 that is created to fit the image in the display frame based on image information similar to that of the image 64 is displayed in a portion of the image 62 that is created based on image information similar to that of the image 60. In short, images created based on the same image information are displayed as the display image and the transfer image.

The description is continued returning to FIG. 6. Subsequently, when determining that it is not the window-move occur event at Step S50 (No), the control unit 26 determines whether it is a communication disconnect event at Step S58. When determining that it is not the communication disconnect event at Step S58 (No), the control unit 26 proceeds to Step S16.

When determining that it is the communication disconnect event at Step S58 (Yes), the control unit 26 performs the range-designation canceling process at Step S60, and completes processing. More specifically, processing is completed by stopping image display on the mobile display unit 32 at Step S60.

In the example illustrated in FIG. 6 through FIG. 14, the setting of the image displayed on the mobile display unit and the process of moving the window have been described; however, processing to be performed by the control unit is not limited thereto. The control unit may be configured to perform, in addition to or in place of processing described above, control of various processes described above, e.g., the process of moving the display frame and the process of moving one window.

In the embodiment described above, as the display units of the display system, the display unit of the PC is used as the one display unit (the second display unit) of the display units, while the mobile display unit of the mobile electronic device is used as the other display unit (the first display unit); however, the present invention is not limited thereto. As the one display unit, a display unit of various types to be viewed by an operator when performing manipulation, e.g., a display unit of mobile electronic device, can be used. As the other display unit, a display unit of a PC, a liquid display panel of various types, a projector, or the like can be used.

### INDUSTRIAL APPLICABILITY

As described above, the display system according to the present invention is suitable for electronic device that causes two display units to display different images.

1. A display system comprising:
a first display unit for displaying a first image;
a second display unit for displaying a second image; and
a control unit for controlling the first display unit and the second display unit, wherein
the control unit causes a portion of the second image, the portion being contained in a specific area in the second display unit, to be displayed on the first display unit as the first image, and
the control unit makes selection of a change mode where a relative positional relationship between the specific area and the second image is to be changed and a fixed mode where the relative positional relationship between the specific area and the second image is fixed available.

2. The display system according to claim 1, wherein
the control unit displays a mark indicating the specific area on the second display unit, and
the mark is any one of a plurality of dots, a line passing through the dots demarcating the specific area, or the mark is one or multiple lines, the one or multiple lines demarcating the specific area.

3. The display system according to claim 1, further comprising:
a first device including the first display unit; and
a second device including the second display unit, and a communication unit for performing communication with the first device, wherein
the control unit transmits image signals for displaying the first image to the first display unit via the external communication unit.

4. The display system according to claim 1, further comprising
an input unit for inputting manipulation, wherein
the control unit changes a shape or a position of at least any one of the specific area and the second image in response to manipulation input to the input unit, and
the control unit causes the first image, in which the changed shape or the changed position is reflected, to be displayed on the first display unit.

5. The display system according to claim 4, wherein
in a situation where the fixed mode is selected, the control unit maintains the relative positional relationship between the specific area and the second image even if manipulation is input from the input unit.

6. The display system according to claim 5, wherein
in a situation where the change mode is selected, the control unit sets the relative positional relationship between the specific area and the second image to be changeable and, when the relative positional relationship is changed by the manipulation input from the input unit, causes a portion of the second image after the relative positional relationship is changed, the portion being contained in the specific area after the relative positional relationship is changed, to be displayed on the first display unit as the first image.

7. The display system according to claim 5, wherein
when, in a situation where the change mode is selected, a shape of the specific area is changed by manipulation input from the input unit, the control unit changes the shape of the specific area and a shape of the portion of the second image collectively so as not to alter the first image displayed on the first unit.

8. The display system according to claim 1, wherein
the second display unit displays, in addition to the second image, a third image created based on image information that is different from that of the second image, and
when the second image and the third image overlap in the specific area the control unit causes a portion of the third image and a portion of the second image, the portions being contained in the specific area, to be displayed on the first display unit as the first image.

9. The display system according to claim 8, further comprising
a storage unit for storing image information, wherein
when the second image and the third image overlap in the specific area, the control unit causes the storage unit to store the image information of the image to be displayed on the first display unit.

10. The display system according to claim 9, wherein
the control unit causes the storage unit to store the image information of the image to be displayed on the first display unit and information about a shape of the specific area or the image.

11. The display system according to claim 1, wherein
when it is detected that the specific area or the second image has not been manipulated for a given time duration, the control unit causes at least any one of the specific area and the second image not to be displayed on the second display unit.

12. The display system according to claim 1, further comprising
a notifying unit for creating a message to be displayed on the second display unit, wherein
the control unit displays the message of the notifying unit on outside of the specific area.

13. A control method for controlling a display system including a first display unit and a second display unit, the control method comprising:
displaying a second image on the second display unit;
causing a portion of the second image, the portion being contained in a specific area in the second display unit, to be displayed on the first display unit as the first image; and
switching between a change mode where a relative positional relationship between the specific area and the second image is to be changed and a fixed mode where the relative positional relationship between the specific area and the second image is fixed.
